(19) United States
(12) Patent Application Publication
(10) Pub. No.: US 2004/0103480 A1
(43) Pub. Date: Jun. 3, 2004

(54) Utensil having closure release pry

(76) Inventor: Carol Carlson-Smith, Simi Valley, CA (US)

Correspondence Address: Mark Levy, SALZMAN & LEVY, 19 Chenango Street - Ste. 902, Binghamton, NY, 13901, US

(21) Appl. No.: 10/306,405

(22) Filed: Nov. 29, 2002

(51) Int. Cl. B25F 1/00

(52) U.S. Cl. 7/112

(57) ABSTRACT

A feeding utensil such as a spoon or fork having a pry for dislodging a tightly fit closure from a receptacle such as a jar. The utensil has a flat, broad handle, with a spoon or fork projecting from one end and a curved arm serving as the pry projecting from the handle. Preferably, the handle is blunt and extends beyond the pry. The pry is located on the handle and configured such that the closure is dislodged by applying a squeezing motion wherein the user's hands are urged towards one another. The utensil may bear any of the group including indicia, non-metallic coloring, metallic coloring, and a temperature indicating material thereon, and any combination of these.

### BACKGROUND OF THE INVENTION

1. Field of the Invention

The present invention relates to a utensil for eating food, adapted to have a pry for dislodging a closure of a receptacle such as a jar.

2. Description of the Prior Art

Feeding of infants, babies, and small children demands a care giver's full attention and deft handling of food related apparatus. In modern households, food is frequently purchased prepared or partially prepared in jars with tightly fitting caps. When a youngster is hungry, he or she is apt to cry or otherwise cause a commotion until the need is addressed by the care giver. Such commotion is a disturbance to the care giver and others in the vicinity of the hungry youngster. Therefore, it becomes very desirable to commence feeding as expeditiously as possible.

Tightly fit caps can be removed with suitable apparatus adapted to engage the cap and pry it free, such as a bottle opener. Frequently, such apparatus is necessary since vacuum packed products cause their respective closures to be so tightly sealed to the associated receptacle that they cannot readily be opened by hand. When access to the food is obtained, the youngster may then be spoon fed.

However, uncomplicated although it may seem, this procedure is subject to delays and annoyance if both required utensils, i.e., the opener and the spoon, are not immediately at hand. This is especially true where the youngster and care giver are away from a household. For example, the youngster may be accompanying the care giver in activities such as shopping, attending restaurants, attending recreation facilities, paying social calls on people located remotely from the youngster's house, among others. Under these circumstances, apparatus which is usually available in known or predictable locations may not be immediately available.

Thus there exists a need for a combined feeding utensil and closure removing tool. The prior art has suggested such combinations. However, the prior art devices lack the practicality and safety features of the combined feeding utensil and closure removing tool of the present invention.

### SUMMARY OF THE INVENTION

The present invention improves on prior art combined implements in several ways. The free, typically pointed end of the pry element is configured to minimize hazards due to casual contact should a youngster gain control thereof. The handle is configured to suit the grasp of an adult. The novel implement optionally bears indicia, such as the name or contact information or both of the manufacturer, instructions for use, or for amusement. The novel implement optionally incorporates temperature responsive material for indicating the temperature of substances into which the food retaining element, such as a spoon or fork, is immersed.

Accordingly, it is one object of the invention to provide a combined eating utensil and closure removing tool.

It is another object of the invention to improve safety and practicality of a combined device.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental, side elevational view of one embodiment of the invention, wherein the novel implement incorporates a spoon.

FIG. 2 is a side elevational view of the embodiment of FIG. 1.

FIG. 3 is a bottom plan view of the embodiment of FIG. 1.

FIG. 4 is a top plan view of the embodiment of FIG. 1.

FIG. 5 is a top plan view of another embodiment of the invention, wherein the novel implement incorporates a fork.

### DETAILED DESCRIPTION OF THE PREFERRED EMBODIMENTS

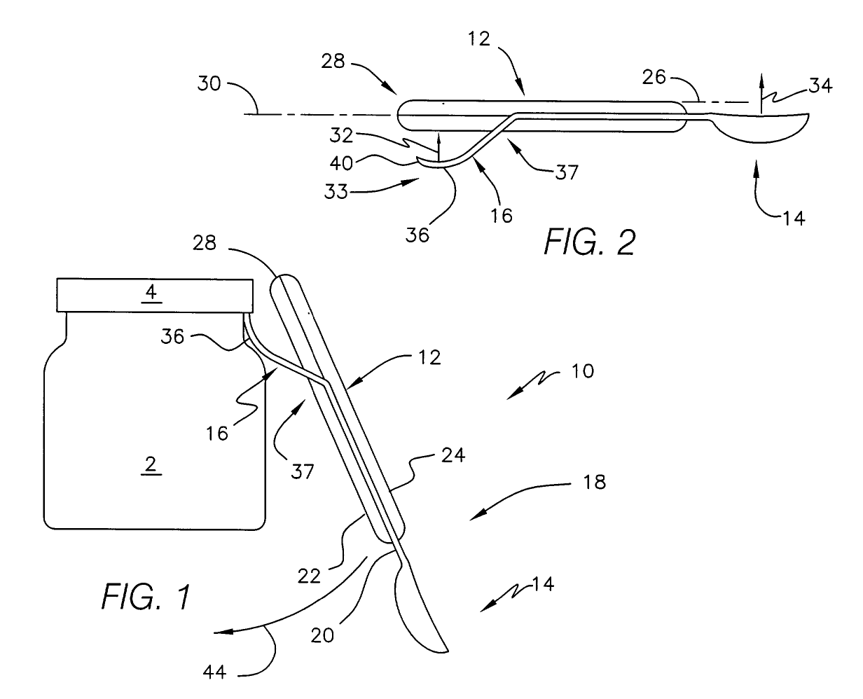

FIGS. 1-3 of the drawings show one embodiment of a novel implement 10 which is a combined eating utensil for engaging and retaining solids and a container closure pry for dislodging a closure which is friction fit to an associated container. Implement 10 includes an elongated handle 12, a food retaining element in the form of a spoon having a bowl 14, and a pry 16 shown engaging the closure of the container. It is anticipated that in most cases the container will be a jar 2 and that the closure will be a cap 4 which is press fit or friction fit to jar 2. Foodstuffs are frequently vacuum packed, and prior the first opening, vacuum resists removal of cap 4 from jar 2. For this reason, pry 16 uses leverage to urge cap 4 upwardly, as depicted in FIG. 1.

Bowl 14 is located at the proximal end 18 of handle 12. Pry 16 projects from handle 12. Handle 12 has sufficient thickness to resist forces imposed on implement 10 when implement 10 is subjected to use as a lever as depicted in FIG. 1. The embodiment of FIG. 1 is preferably formed from a single base section 20 of a metal or metallic alloy, such as stainless steel. Handle 12 also has additional handle sections 22, 24 formed by molding from a synthetic polymer or any other suitable material, which could include metals and their alloys. Of course, sections 22, 24 could be formed as a single component (not shown) encircling base section 20. It is anticipated that polymeric handle sections 22, 24 display at least one non-metallic color, such as, for example, a bright primary color including at least one of the group including red, blue, yellow, orange, yellow, purple, green, or a non-chromatic color such as white, gray, or black. Bowl 14 and pry 16 could be a metallic color, such as that of native stainless steel, chromium, aluminum, copper or brass, a metallic compound such as a nitride of a metal, or an anodized metal. Of course, it would be possible to render bowl 14 in a more conspicuous color than an unadorned metallic color to encourage children to focus on the spoon rather than on a potentially more hazardous component such as pry 16.

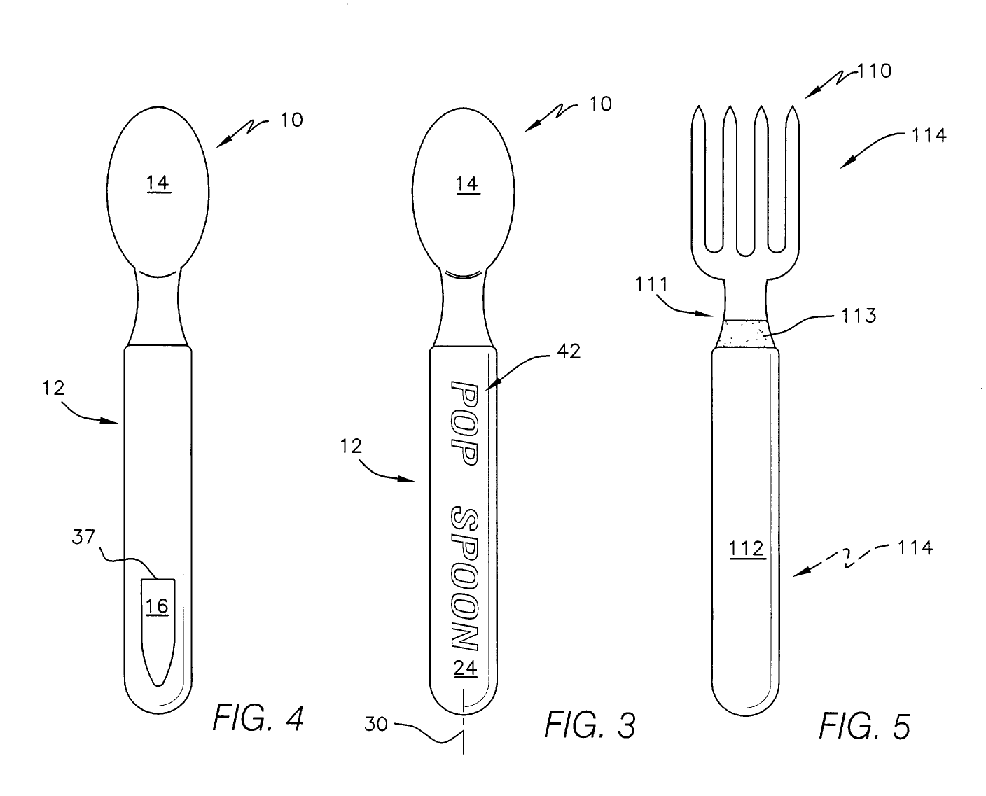

Looking particularly at FIG. 3, handle 12 is seen to have a facial surface 24 which in the embodiment of FIG. 3 has width of magnitude greater than that of the thickness of handle 12. Facial surface 24 defines a facial plane 26 (see FIG. 2) located along and occupied by facial surface 24. It will be appreciated that the relative width of facial surface 24 is not critical to the invention, as handle 12 could be cylindrical for example, but rather is presented for semantic purposes in describing structural characteristics. Handle 12 has a blunt distal end 28 located along a longitudinal axis 30. Proximal end 18 of handle 12 is also located along longitudinal axis 30.

Pry 16 comprises a curved arm displaying concavity, when viewed in side elevation. As indicated by arrow 32, this concavity faces only towards facial plane 24. The curvature of pry 16 causes the distal or free end 33 of pry 16 to project in a direction which if sufficiently extended would intersect facial plane 26 of handle 12.

Bowl 14 also has concavity, indicated by arrow 34. Concavity of both bowl 14 and pry 16 face in similar directions with regards to facial plane 26. Alternatively stated, the concavity of bowl 14 and of pry 16 face upwardly, as depicted in FIG. 2. It will be appreciated that the significance of facial plane 26 is only to represent a location on implement 10 for purposes of describing orientation of curvature. Obviously, it will be apparent that section 22 (FIG. 1), could be substituted for facial plane 24 for the purposes of describing orientation of curvature of pry 16 and of bowl 14. Similarly, it will be appreciated that facial plane 26 need not literally be planar. The outer surface which is planar in the embodiment of FIG. 1 could alternatively be convex, concave, or otherwise configured.

Curvature of pry 16 is of configuration and dimensions as to establish a fulcrum located at 36 when pry 16 bears against jar 2 and engages cap 4 in a position to pry cap 4 from tight engagement with jar 2. The entirety of the fulcrum is contained on the arm of pry 16. The proximal end 37 of pry 16, which is that affixed to handle 12. Free distal end 33 of pry 16 faces away from bowl 14. Optionally, pry 16 terminates in a hook 40 for engaging a lip (not separately shown) of cap 4.

In the embodiment of FIG. 1, and as clearly seen in FIG. 2, handle 12 extends at its distal end 28 entirely beyond pry 16. This characteristic protects distal end 33 of pry 16 from casual contact by a child who might injure himself or herself, especially in those embodiments wherein hook 40 is present, by overlying pry 16. Pry 16 is also visually shielded to a certain extent by handle 12, so that pry 16 is less conspicuous and less likely to become the object of unwanted attention by a youngster.

FIG. 3 shows a further optional feature, wherein indicia 42 is disposed upon handle 12. In the example of FIG. 3, indicia 42 spells out a possible trademark identifying implement 10 as a proprietary product. Other examples of indicia could include manufacturer or distributor advertising, contact information (not shown), such as a web site, or instructions pertaining to use of implement 10. It will be recognized that the specific indicia forms no part of the instant invention.

FIG. 5 shows an implement 110 of another embodiment of the invention wherein the food retaining element is a fork 114. Implement 110 has a handle 112 and a pry (not visible in the top plan view of FIG. 5), handle 112 and pry being essentially similar to those of the embodiment of FIG. 1. Fork 114 preferably exhibits curvature corresponding to that of bowl 14 of the embodiment of FIG. 1.

Another optional feature is shown in FIG. 5. A portion of stem 111 of fork 114 bears a temperature indicating material 113 thereon. Temperature indicating material 113 is of any known type of material which changes its visual characteristics in a predetermined manner with variations in temperature to which it is exposed. It would be possible to locate material 113 on the tines of fork 114, or on bowl 14 of the embodiment of FIG. 1 or the stem thereof, or even upon the handle of any embodiment.

FIG. 1 shows a method of using implement 10. With pry 16 engaging cap 4 of jar 2 as shown, and with fulcrum 36 bearing against jar 2, manual force is exerted in the direction indicated by arrow 44. This is an ergonomically more comfortable and natural situation for prying cap 4 loose, since it is not necessary to grasp jar 2 securely when removing cap 4. By contrast, many prior art cap removing devices (none shown) locate the fulcrum above a dog which engages cap 4, thereby requiring the user to move the device in a direction opposite that required by the present invention. Such action tends to pull jar 2 in the same direction, which action requires the user to resist such motion of jar 2, typically requiring encircling grasp of the container.

By contrast, in the present invention, there is no necessity for wrapping the hand or fingers around jar 2, as is required with prior art devices operating in the opposite direction. Alternatively stated, a moment exerted by grasping jar 2 in one hand, with cap 4 facing upwardly, is countered by an opposed moment exerted by grasping handle 12 in the other hand, and urging handle 12 to rotate as indicated by arrow 44. This occurs because implement 10 is configured to engage cap 4 by pry 16 wherein fulcrum 36 is located between the free end 33 which engages cap 4 and proximal end fixed to handle 12, with curvature of pry 16 facing facial plane 26.

Orientation of curvature of pry 16 and of bowl 14 (or of corresponding curvature of fork 114) in a similar direction does not affect the counter-oriented moments, but results in locating pry 16 on the opposite side of handle 12 from the receptacle of bowl 14. This helps divert a youngster's attention away from pry 16, which further promotes safety.

It is to be understood that the present invention is not limited to the embodiments described above, but encompasses any and all embodiments within the scope of the following claims.

I claim:

1. A combined eating utensil for engaging and retaining foods and a container closure pry for dislodging a closure of a container friction fit to the container, comprising:
an elongated handle having a facial surface defining a facial plane located along, occupied by, and projecting from said facial surface, a longitudinal axis, a proximal end located along said longitudinal axis, and a distal end located along said longitudinal axis;
a food retaining element disposed at said proximal end of said handle; and
a pry projecting from said handle, said pry comprising a curved arm having concavity facing only towards said facial plane defined by said facial surface of said handle, said concavity being of configuration and dimensions as to establish a fulcrum disposed entirely on said pry when said pry engages the closure of the container in a manner enabling said pry to pry the closure from tight engagement with the container, wherein said pry has a proximal end fixed to said handle and a distal end facing away from said food retaining element.

2. The combined eating utensil according to claim 1, wherein said handle extends at said distal end entirely beyond said pry and said distal end of said handle is blunt.

3. The combined eating utensil according to claim 1, wherein said curvature of said pry causes said distal end of said pry to project in a direction which if sufficiently extended would intersect said facial plane of said facial surface of said handle.

4. The combined eating utensil according to claim 1, wherein said distal end of said pry terminates in a hook for engaging a lip of the closure of the container.

5. The combined eating utensil according to claim 1, further comprising indicia disposed thereon.

6. The combined eating utensil according to claim 1, further comprising temperature indicating material disposed thereon.

7. The combined eating utensil according to claim 1, wherein said food retaining element comprises a spoon having a bowl.

8. The combined eating utensil according to claim 7, wherein said concavity of said pry faces a direction substantially the same as that of said bowl of said spoon.

9. The combined eating utensil according to claim 1, wherein said food retaining element comprises a fork.

10. The combined eating utensil according to claim 1, wherein said pry displays a metallic color and said handle displays at least one non-metallic color.

11. The combined eating utensil according to claim 1, wherein said food retaining element displays a metallic color and said handle displays at least one non-metallic color.

12. A combined eating utensil for engaging and retaining foods and a container closure pry for dislodging a closure of a container friction fit to the container, comprising:
an elongated handle having a facial surface defining a facial plane located along, occupied by, and projecting from said facial surface, a longitudinal axis, a proximal end located along said longitudinal axis, and a distal end located along said longitudinal axis;
a food retaining element disposed at said proximal end of said handle; and
a pry projecting from said handle, said pry comprising a curved arm including a fulcrum, wherein said pry is dimensioned, configured, and located on said combined eating utensil in an orientation so as to establish a first moment exerted by grasping the container in one hand, with the closure of the container facing upwardly, and an opposed moment exerted by grasping said combined eating utensil in the other hand when the two hands are urged towards one another while grasping the container and said combined eating utensil.

13. The combined eating utensil according to claim 12, wherein said handle extends at said distal end entirely beyond said pry and said distal end of said handle is blunt.

14. The combined eating utensil according to claim 12, wherein said distal end of said pry terminates in a hook for engaging a lip of the closure of the container.

15. The combined eating utensil according to claim 12, further comprising indicia disposed thereon.

16. The combined eating utensil according to claim 12, further comprising temperature indicating material disposed thereon.

17. The combined eating utensil according to claim 12, wherein said food retaining element comprises a spoon having a bowl.

18. The combined eating utensil according to claim 17, wherein said concavity of said pry faces a direction substantially the same as that of said bowl of said spoon.

19. The combined eating utensil according to claim 12, wherein said food retaining element comprises a fork.

20. The combined eating utensil according to claim 12, wherein said food retaining element displays a metallic color and said handle displays at least one non-metallic color.
